(19) United States
(12) Patent Application Publication
(10) Pub. No.: US 2016/0130752 A1
(43) Pub. Date: May 12, 2016

(54) METHOD FOR THE TREATMENT OF SPENT PULPING LIQUOR FOR THE REMOVAL AND PRODUCTION OF A LIGNIN CONTAINING PRODUCT

(71) Applicant: KIRAM AB, Bjärred (SE)

(72) Inventors: Lars STIGSSON, Bjaerred (SE); Anders ARKELL, Malmoe (SE); Johanna OLSSON, Lund (SE)

(21) Appl. No.: 14/893,739

(22) PCT Filed: May 9, 2014
(86) PCT No.: PCT/SE2014/050572

§ 371 Date: Nov. 24, 2015

(30) Foreign Application Priority Data
May 29, 2013 (SE) 1350648-0
Dec. 30, 2013 (SE) 1351587-9

(51) Int. Cl. D21C 11/00; C07G 1/00; C02F 1/44

(52) U.S. Cl. CPC D21C 11/0007; C02F 1/442; C02F 1/444; C07G 1/00; C02F 2103/28

(57) ABSTRACT

The present invention describes a method for the treatment of spent pulping liquor for the removal and production of organic substances rich in lignin and recovering or recycling of aqueous cooking chemicals to pulp mill chemicals recovery cycle, said method comprising passing a spent pulping liquor flow from a digester or an evaporator, DF or from any other step in between the digester and the evaporator, through a filtration step in which the flow is separated into one aqueous stream comprising cooking chemicals being recovered or recycled and one stream concentrated with the respect of organic substances; passing the stream concentrated with respect of organic substances either to a lignin depolymerisation step for the production of liquid and pumpable depolymerised lignin or passing the stream concentrated with respect to organic substances to a subsequent filtration step in which an aqueous solution is added and further treatments in order to produce a solid lignin containing product.

### FIELD OF THE INVENTION

The present invention relates to a method for treating spent pulping liquor for the removal and production of a lignin containing product and/or a stream of depolymerised lignin.

### TECHNICAL BACKGROUND

There are known methods today for recovering lignin from spent pulping liquor or black liquor. One such method is disclosed in US2008/0051566, said method being directed to precipitating lignin from a lignin containing liquid/slurry, such as black liquor, and comprising addition of one or more compounds comprising sulphate or sulphate ions, or a mixture comprising said compound, to said liquid/slurry, adjustment of the pH level of the said liquid/slurry by acidifying using CO₂ wherein the pH level is adjusted, and dewatering of said liquid/slurry so that a lignin product, or an intermediate lignin product, is obtained. Moreover, in US2008/0047674 there is disclosed a method for separating lignin from black liquor, said method also comprising precipitating lignin by acidifying, preferably by using carbon dioxide.

Furthermore, in WO2010/143997 there is disclosed a method for separation of lignin from original black liquor, the method comprising precipitation of lignin by a first acidification stage of the original black liquor, followed by dewatering while forming a first filter cake with high content of lignin, suspending the first lignin filter cake in a second acidification stage, wherein a second lignin suspension is obtained, dewatering of the second lignin suspension forming a second filter cake with high content of lignin, washing the second filter cake water and finally dewatering of the washed second lignin cake obtaining a lignin product. Also in this case carbon dioxide is a preferred acidifying agent to use, in this case in the first acidification stage.

Moreover, in US2010/0041879 there is disclosed a method for recovering a low sodium content lignin from spent kraft cooking liquor without the use of a strong mineral acid for acidulation, said method comprising the steps of acidulating a spent kraft cooking liquor with carbon dioxide gas to a pH below about 10.5, precipitating at least a portion of the lignin forming lignin agglomerates and lignin particles in the spent kraft cooking liquor and recovering a low water and low sodium content lignin product comprising calcium or magnesium compounds bound to said lignin.

There are some drawbacks to the methods disclosed above. One of them is the loss of hydrogen sulphide ions and formation of hydrogen sulphide by the acidulation of the spent kraft cooking liquor. Formed hydrogen sulphide need to be captured and reformed to active kraft cooking chemicals. Alkalinity is lost by the acidic treatment of the liquor and re-alkalization may be necessary before returning sodium salts to the spent cooking liquor stream. Apart from the cost of alkali any re-alkalization may affect the sodium/sulphur balance negatively. Furthermore, the methods disclosed above comprise the addition of expensive chemicals, such as carbon dioxide.

Several methods for depolymerisation of lignin are well known in the prior art, such methods for example including base catalysed depolymerisation with alkali salts followed by hydrogenation in order to produce renewable gasoline components disclosed in WO1999010450A1 (Shabtai) and in EP1888713 (Zmierczak).

One objective of the present invention is to provide an effective method for treating spent pulping liquor/black liquor, which method overcomes the problems disclosed above, i.e. a method which permits the recovery and separation of lignin from kraft pulping liquor without concomitant loss of active alkali in the form of hydrogen sulphide and hydroxide ions and which substantially avoids the need of re-alkalization of the spent cooking liquor. Another objective of the present invention is to provide an integrated process for the efficient recovery of lignin from spent kraft pulping liquor and concomitant production of depolymerised lignin for use in fine chemicals production or as precursor for production of renewable fuels.

### SUMMARY OF THE INVENTION

The stated objectives above is achieved by a method for the treatment of spent pulping liquor for the removal and production of organic substances and recovering or recycling of aqueous cooking chemicals, said method comprising: passing a spent pulping liquor flow from a digester or an evaporator, or from any other step in between the digester and the evaporator, through a filtration step in which the flow is separated into one aqueous stream comprising cooking chemicals being recovered or recycled and one stream having a concentrated content of organic substances; passing the stream having a concentrated content of organic substances directly or indirectly without drying to a lignin depolymerisation reactor system or passing the stream through a subsequent filtration step in which water is added and in which the stream is separated into one aqueous stream comprising cooking chemicals being recovered or recycled and one stream having a further concentrated content of organic substances; directing the flow with further concentrated content of organic substances from the subsequent filtration step to an acid treatment step for precipitation of at least lignin; and directing a product flow comprising at least lignin from the acid treatment to a solid/liquid separation step in which a solid lignin containing product is separated and recovered.

As notable from above, one aspect of the present invention is directed to a process comprising at least two filtration steps before the acid treatment instead of a pre-treatment comprising an acidifying step such as disclosed in all of US2008/0051566, US2008/0047674, WO2010/143997 and US2010/0041879. In all of these the focus is directed to methods in which the black liquor is acidified using acid or carbon dioxide before the corresponding subsequent acid treatment is performed. In US2008/0051566, US2008/0047674 and WO2010/143997 the lignin is precipitated after the first acidification with carbon dioxide, then the lignin is separated and the acidified remaining liquor is exposed to an alkali treatment to increase the pH value again so that it may be returned to the process again. This is very different when compared to the present invention. According to the present invention, the filtration steps enable to separate lignin without using an early acidification step. As such, the present process is very cost-effective in terms of savings in additives like carbon dioxide and importantly, it preserves the major portion of active cooking chemicals in the form of hydroxide ions and hydrosulphide ions in the black liquor. The method disclosed in US2010/0041879, which is directed to ion exchanging the lignin is not preserving the active cooking chemicals, while the disadvantage in using acidulation for lignin precipitation is avoided.

Furthermore, a similar technology to the methods disclosed in US2008/0051566, US2008/0047674 and WO2010/143997 is presented in the article “Chemical pulping The influence of hemicelluloses during the precipitation of lignin in kraft black liquor” (Henrik Wallmo and Hans Theliander, Chalmers University of Technology, Gothenburg, Sweden, A.-S. Jonsson and O. Wallberg, Lund University, Sweden, K. Lindgren, STFI-Packforsk AS, Stockholm, Sweden) from Nordic Pulp and Paper Research Journal Vol 24 no. 2/2009. This article relates to a lignin precipitation process in which carbon dioxide is added, i.e. just as disclosed above. As notable from the article, trials were made where ultrafiltration and nanofiltration were combined with the lignin precipitation process comprising carbon dioxide addition. However, there is no hint what so ever from the article to provide a process focused on a staged filtration procedure as the key feature taken alone or in combination with an integrated process for the depolymerisation of lignin. By the use of carbon dioxide acidulation as thought by the article, a substantial amount of active cooking chemicals will be lost along with excessive formation of hydrogen sulphide gas. The article thus does not disclose the key feature of the process of the present invention resulting in that substantially all hydrogen sulphide ions in the spent kraft cooking liquor is preserved as active cooking chemicals.

The present invention is directed to a process involving several filtration steps and, in order to preserve hydrogen sulphide in its active form, no carbon dioxide or other acid is added prior to final precipitation of lignin from a concentrated lignin stream, i.e. acid treatment is performed only after the filtration and separation steps are performed.

In “Purification of Lignin Fuel from Kraft Black Liquor by Diafiltration”, Examensarbete for Civilingenjörsexamen, Lunds Tekniska Högskola, Lunds universitet, Kemiteknik, 2004, (JOHANSSON, C.) there is disclosed a method for purification of lignin fuel from kraft black liquor by diafiltration. The aim of the investigation is to experimentally investigate the influence of diafiltration influence on ash content and lignin yield after ultrafiltration of kraft black liquor and to investigate the influence of the operating parameters volume reduction and diafiltration factor. The investigation show that the ash content may be decreased by use of diafiltration, however although precipitation of lignin from diafiltrated black liquor could be performed without problems the filtration of the solution proved to be very difficult and the filter paper was clogged almost immediately.

There are several key differences between the method disclosed in JOHANSSON, C., “Purification of Lignin Fuel from Kraft Black Liquor by Diafiltration” and the present invention. First of all, the present invention is directed to the recovery of lignin and the concomitant recycling of cooking chemicals in its active form, including both alkali and different sulphuric compounds, which is a key feature with respect to the mill chemical balance hence the overall economy of a lignin recovery process. The method according to “Purification of Lignin Fuel from Kraft Black Liquor by Diafiltration” does not show or hint such recovery or recycling of active cooking chemicals. Secondly, the filtration steps disclosed are not performed in the same manner. In accordance with “Purification of Lignin Fuel from Kraft Black Liquor by Diafiltration” article it is suggested that the filtration of the solution after lignin precipitation is very difficult to perform. The filtration step according to “Purification of Lignin Fuel from Kraft Black Liquor by Diafiltration” is performed at room temperature, which is outside the temperature range of the filtration steps of the present invention. The purpose of the work described in “Purification of Lignin Fuel from Kraft Black Liquor by Diafiltration” is to provide a lignin with a low ash content, while the present invention is related to the recovery of a lignin product, which optionally may be depolymerized, concomitant with the recycling of active cooking chemicals to the spent cocking liquor stream. As disclosed herein the present invention provides an effective method in terms of lignin yield (whether the lignin is depolymerised or not) and recirculation and recovery of active aqueous cooking chemicals distinguishing itself from the prior art.

Furthermore, in “Preparation of High-Purity Sulphate Lignin from Spent Black Liquor Using Ultrafiltration and Diafiltration Processes”, Desalination, 1998, July, Vol. 115, pages 111-120, (TANISTRA, I., BODZEK, M.) there is disclosed a ultrafiltration process of black liquor using ultrafiltration polyacrylonitrile membranes. The ultrafiltration process can be combined with diafiltration, i.e., by removing residual impurities with an extra amount of water added in the process. Also in this case the same arguments as presented above are valid. Recovery or recycling of aqueous cooking chemicals, which is a key feature with respect to the mill chemicals balance and hence economy of a kraft pulping process with an integrated lignin recovery step, are not addressed. Moreover, acid treatment and subsequent solid/liquid separation for precipitation of lignin from a edentate of a filtration step is not suggested or shown in the article above which points away from the present invention.

In relation to the above description of the present invention and its high level of recirculation and recovery of active aqueous cooking chemicals (i.e. hydroxide ions, hydrosulphide ions) it may further be said that at least 75% of the total input of aqueous cooking chemicals is recovered or recycled without having been subjected to acidulation according to the present invention. According to one specific embodiment, at least 80%, such as up to or even above 90%, of the total input of aqueous cooking chemicals is recovered or recycled without having been subjected to acidulation treatment.

In relation to some of the expressions used above, the following may be stated. The expression “recovered or recycled” implies that the aqueous stream comprising cooking chemicals may be both directly and indirectly used in other parts of the process involved. As an example, recycling may imply recycling the aqueous stream comprising cooking chemicals to a pulp mill recovery cycle.

Furthermore, the filtration step involving water addition may also be called diafiltration.

Moreover, according to another embodiment of the present invention, a catalytic lignin depolymerisation step is integrated in the lignin recovery system of the present invention.

### BRIEF DESCRIPTION OF THE DRAWINGS

FIG. 1 shows one possible process flow set-up according to one embodiment of the present invention.

FIG. 2 shows one possible process flow set-up according to another embodiment of the present invention.

FIG. 3 shows the set-up during the trials disclosed below for ultrafiltration and nanofiltration, respectively, with ceramic membranes.

FIG. 4 shows a process flow set-up according to another embodiment of the present invention, wherein a catalytic depolymerisation step is integrated in the lignin recovery plant.

FIG. 5 shows yet another process flow set-up and embodiment directed to a basic catalytic depolymerisation step integrated in the lignin plant

### SPECIFIC EMBODIMENTS OF THE INVENTION

Below, specific embodiments according to the present invention are disclosed.

The lignin containing spent pulping liquor starting material used in the process of the invention may be of different types mainly depending on the pulping process and the wood raw material fed to the pulp mill. According to one specific embodiment, the spent pulping liquor is a kraft black liquor or a spent cellulose liquor originating from a soda pulping process.

Apart from lignin the spent pulping liquor contains spent cooking chemicals which chemicals needs to be recycled and reformed to fresh cooking chemicals within the pulp mill. A kraft black liquor is highly alkaline and has a pH value between 11 and 13. The black liquor contains both sodium hydroxide and sodium sulphide which both are active kraft cooking chemicals. The total content of inorganic salts dissolved in the kraft black liquor including the active cooking chemicals varies between 15 and 30% by weight of the black liquor solids. The variation is mainly due to wood raw material and pulp product from the mill. It is a key objective of the present invention to recycle a major portion of these dissolved inorganic salts to the pulp mill chemicals recovery cycle prior to any substantial change in pH of the black liquor stream by addition of acid.

Furthermore, it is of great importance to ensure that the pH value in streams charged or recycled to a chemicals recovery cycle of a kraft pulp mill always is kept above about 11 in order to minimize evolution of toxic and odorous hydrogen sulphide gas.

In the following text and in the claims these dissolved salts present in the spent pulping liquor is referred to as aqueous cooking chemicals.

The filter types used in the process may also be of different type, however membrane filters are preferred. Therefore, according to one specific embodiment of the present invention, at least one of the filtration steps is based on using membranes. According to yet another embodiment, both filtration steps are based on using membranes. It should be noted that the process according to the present invention may comprise more filtration steps than two, which is further discussed below, and such added steps may also be in the form of membrane filtration. Furthermore, modules may be used comprising more filters connected so that at least one filter may be by-passed during washing or maintenance of that filter.

According to one specific embodiment of the present invention, the membrane filtration(s) is nanofiltration and/or ultrafiltration. Both of these techniques and types of filters, i.e. ultrafilters and nanofilters, and the difference thereof are known. Nanofiltration and or ultrafiltration is distinguished by, the parameter cut-off, which is a measure of the density of the membrane. Typical values for the cut-off of an ultrafilter are in the range of 10-100 kg/mol. For nanofiltration and fine ultrafiltration membranes, the cut-off is normally in the range 0.1-15 kg/mol.

As mentioned above, several filtration steps, and different types thereof may be comprised in a set-up according to the present invention. According to one specific embodiment, the method also comprises at least one additional filtration step performed before the acid treatment, said filtration step involving a separation of the input stream into one aqueous stream comprising cooking chemicals being recovered or recycled and one stream having a concentrated content of organic substances.

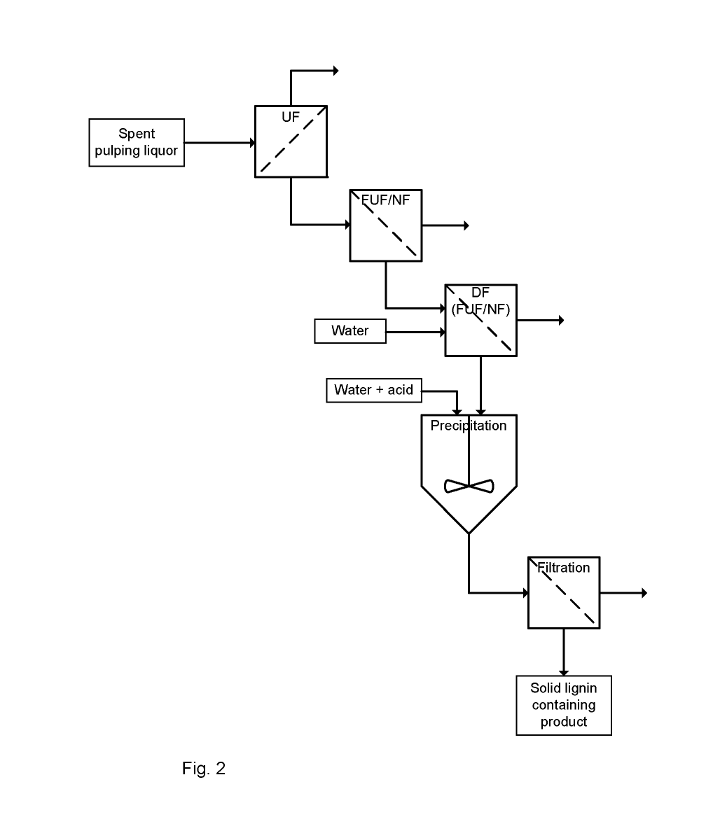

Furthermore, according to yet another specific embodiment, the method also comprises a pre-filtration step, said pre-filtration step involving a separation of the input stream of spent pulping liquor flow into one stream with large undesired molecules and one stream intended to be further filtrated. Such a filter may be the first one presented in the set-up example shown in FIG. 2. Such a pre-filtration step is of special importance when the spent pulping liquor is based on hardwood (deciduous wood) as the hardwood liquor normally comprise a relatively high content of large polysaccharide molecules that may be separated from the liquor in such pre-treatment step. According to one specific embodiment, such pre-filtration removing undesired large molecules including polysaccharides and particles is an ultrafiltration.

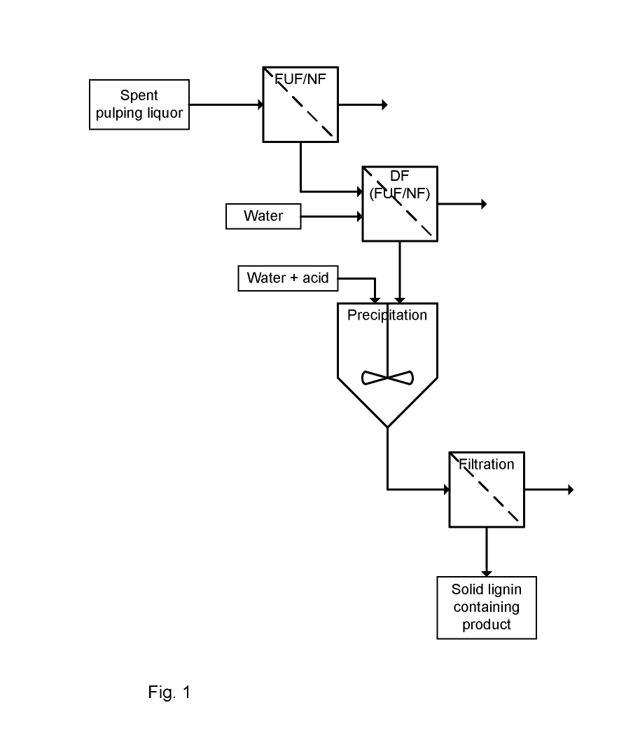

Moreover, according to yet another embodiment, the solid/liquid separation step in which a solid lignin containing product is separated and recovered comprises at least one filter pressing step. According to yet another embodiment, this solid/liquid separation comprises a decanting step or a centrifugation step. The solid/liquid separation step is shown in both FIG. 1 and FIG. 2 after the acid treatment step. The solid/liquid separation step may be performed in one or more stages. In one embodiment, the solid/liquid separation step comprises more than one filtration step wherein at least one filtration step involves the addition of water and acid. This addition is performed for washing performance reasons. Sulphuric acid can advantageously be used for acidulation, as sulphuric acid is used in kraft mills and any sulphates can be recycled to the chemicals recovery cycle. Nevertheless other acids can also be used for acidulation including mineral acids and organic acids.

It should further be said that the lignin product obtained after acidic treatment and subsequent lignin precipitation besides ash also may contain more or less organic compounds originating from the celluloses in the wood. One such component following the lignin is hemicellulose. Therefore, according to one embodiment, organic product substances are at least lignin and hemicellulose, and wherein both are separated and present in the lignin product.

The conditions used during filtration and lignin precipitation may differ depending on the spent pulping liquor treated and also the type of set-up according to the present invention. According to one specific embodiment, the water content in the feed to the filtration step in which water is added is up to 40 wt % when measured in relation to the feed of spent pulping liquor to the filtration.

According to one embodiment, the temperature in at least one of the filtration steps is held above 85° C., e.g. above 90° C. and preferably above 100° C. Temperatures well above 100° C., such as up to 150° C. are fully feasible using ceramic membranes. For instance, a temperature in the range of 100-140° C. may suitably be employed in an ultra and/or nanofiltration step, e.g. 120° C.

Furthermore, according to one embodiment, the temperature is held in the range of 30-100° C. in the acid treatment for precipitation of at least lignin. The temperature used in the acid treatment step is normally lower than in the filtration steps. The temperature in the acidulation step is selected based on the properties of the feed to the acidulation step as pH, hemicellulose content etc. A suitable temperature range for the acidulation step is e.g. 50-90° C. for many embodiments according to the present invention. Moreover, also other parameters are important in the acid treatment, especially the pH value. According to one specific embodiment, the pH value is held below 10 in the acid treatment for precipitation of at least lignin. A pH value of from 3-8 may be used, e.g. 3-6, e.g. around a pH value of 4. According to one specific embodiment, the pH value is held in the range of 3-8 in the acid treatment for precipitation of at least lignin. According to another embodiment, the pH range in the acidulation step is adjusted by the addition of acid targeting a pH range of from 4-5.

As notable from above, the process according to present invention is not directed to the use of several different acids or other additives for the recovery of lignin. Besides water and selected acid, no other or at least no other considerable additives are needed.

In addition to the method, the present invention is also related to a system configuration. According to one embodiment, the present invention is directed to a system for the treatment of spent pulping liquor for the removal and production of organic substances and recovering or recycling of aqueous inorganic cooking chemicals, said system comprising:
a) a filter unit arranged to separate a spent pulping liquor flow from a digester or an evaporator, or from any other step in between the digester and the evaporator in a pulp mill, into one aqueous stream comprising a major portion of the cooking chemicals present in the spent pulping liquor being recovered or recycled and one stream having a concentrated content of organic substances;
b) a subsequent filter unit, said filter unit involving water adding capabilities and being arranged to separate the stream having a concentrated content of organic substances into one aqueous stream comprising cooking chemicals being recovered or recycled and one stream having a concentrated content of organic substances;
c) an acid treatment step wherein the stream having a concentrated content of organic substances from b) is acidulated by the addition of an acid in order to precipitate lignin and forming an aqueous brine comprising sodium salts, and
d) a solid/liquid separation unit arranged to separate precipitated lignin from brine in order to produce a solid lignin containing product.

According to one specific embodiment, at least one of the filter units is a membrane filtration unit. The set-up may comprise several membrane filters in series and/or parallel, also filters of different type, e.g. both ultrafilters and nanofilters. As alluded to hereinabove the set-up may have extra filtration units only intended to uphold the availability of the system, so that washing and maintenance cycles may be performed when the system is operating.

Moreover, according to one specific embodiment, the system also comprises at least one additional filter unit positioned before the acidulation step, said filter unit arranged for a separation of the input stream into one aqueous stream comprising cooking chemicals being recovered or recycled and one stream having a concentrated content of organic substances. Furthermore, the system may also comprise a pre-filter unit, said pre-filter unit arranged for a separation of the spent pulping liquor feed into one stream with large undesired molecules and one stream being further filtrated. This pre-filter may e.g. be an ultrafilter.

Moreover, the solid/liquid separation unit may be configured in different ways. According to one embodiment, the solid/liquid separation unit comprises at least one filter press. Moreover, according to another embodiment the solid/liquid separation unit comprises at least one decanter or centrifuge.

According to another aspect of the present invention there is provided a method wherein lignin is depolymerized within the lignin separation process of the present invention. A lignin depolymerisation step is preferably performed on the retentate (concentrated stream of organic substances from a spent cooking liquor filtration unit) discharged from a first filtration step wherein the permeate (an aqueous solution comprising a major portion of the cooking chemicals, such as sodium and sulphur compounds) have been separated and recycled to the chemicals recover cycle. The retentate may be charged directly without prior concentration to the depolymerisation step and any alkali and sulphur compounds present in the retentate may act as catalysts in the depolymerisation step. Thus the lignin concentration in the feed stream charged to a lignin depolymerisation step is considerably increased relative to the concentration of lignin in the spent cooking liquor. One or more catalysts may be added to the depolymerisation step in order to promote breakdown of the lignin macromolecule to smaller fragments. The catalyst may be composed of the inorganic chemicals present in the retentate only (sodium and sulphur salts, hydroxide ions). Optionally alkali in the form of potassium carbonate can be added to present in the depolymerisation step.

In addition one or more heterogeneous catalysts may also be present during catalyzed depolymerisation of the lignin in a depolymerisation step. In order to prevent undesired recondensation reactions during depolymerisation a capping agent or a solvent may be present in the depolymerisation step. Such solvents include recycled depolymerized lignin product, phenols, vinyl acetate, butyl acetate, ethyl acetate, turpentine, cresol, light gasoil and BTX solvent recovered from nafta cracking. In addition formic acid, furans such as THF, organic acid rich hydrolysates from separation of hemicellulose from wood or C1-C4 alcohols may be present during depolymerisation of lignin in a depolymerisation step. The depolymerisation step may be performed in continuous or batch reactors, preferably tubular reactors or CSTRs (continuous stirred tank reactors). Preferred solvents present during depolymerisation of the retentate stream includes one or more of water, liquid carbon dioxide, hydrolysates, turpentine and/or methanol recovered in a chemical pulp mill or chemical dissolving pulp mill. It is particularly advantageous to recycle a portion of the depolymerised lignin product stream to the depolymerisation step.

Particularly advantageous heterogeneous and sulphur tolerant catalysts that may be added to promote lignin depolymerisation(and partial deoxygenation) include Ni based catalysts supported on Al and/or Si supports, calcium compounds and Zr, Mo (MoS₂) and Cu compounds on support. Potassium carbonate is a preferred homogeneous catalyst. The heterogeneous catalysts can be separated from the lignin streams by for example magnetic separation or filtration and be recycled to the reactor with or without reactivation (decoking)

Although specific process conditions in the depolymerisation step dependent on the catalyst and solvent selected may vary, typical reaction temperature in the catalytic step ranges from about 200 C to 375° C. The liquid hourly space velocity in a depolymerisation reactor is from 0.5 to 6 hours.

Gases formed in a depolymerisation reactor (mainly carbon dioxide and hydrogen sulphide) may be removed from time to time or continuously from the reactor.

Depolymerised lignin which is discharged from the reactor with the solvent may be concentrated by any or more of liquid-liquid extraction with a solvent, acidulation with an acid such as carbon dioxide or a mineral acid, membrane separation or centrifugation. In a preferred embodiment the depolymerised lignin is recovered in the form of a pumpable liquid .Any lignin rich solids or aqueous streams comprising salts are recycled to the spent cooking liquor stream charged to the evaporators/recovery boiler. Acidic streams can be discharged to a crude tall oil acidulation plant or be neutralized and charged to the spent cooking liquor stream. Depolymerised lignin (coming from a molecular weight of 10 000 or more in the spent liquor down to about 300-500 g/mol after the depolymerisation step) may be further upgraded by treatment with hydrogen donor solvents or hydrogen in one or more catalytic steps in order to form components suitable for use in renewable diesel or renewable gasoline.

Based on the disclosure above, according to one aspect of the present invention there is provided a method for the treatment of spent cooking liquor for the removal and production of a stream of depolymerised lignin and recovering or recycling of aqueous cooking chemicals, said method comprising:
passing a spent cooking liquor discharged from a digester or an evaporator in a pulp mill, or from any other step in between a digester and an evaporator, through at least one filtration step in which the spent cooking liquor is separated into one aqueous stream comprising cooking chemicals (permeate) being recovered or recycled and one stream having a concentrated content of lignin (retentate);
passing the stream having a concentrated content of lignin to a lignin depolymerisation step consisting of one or more reactors in order to produce a stream of depolymerised lignin.

According to one embodiment one or more catalysts are added to be present during depolymerisation step. According to one specific embodiment, one or more solvents are added to be present during the depolymerisation step.

One embodiment of the second aspect of the present invention involves a method comprising:
providing a spent cooking liquor feedstock
separating aqueous cooking chemicals and lignin from the black liquor feedstock by one or more filters
contacting lignin with a solvent in order to form a stream comprising lignin and solvent
contacting the stream of lignin and solvent with a catalyst in a reactor in order to form an intermediate liquid lignin stream wherein a first portion of the intermediate lignin stream is recycled to form the solvent
processing at least a second portion of the liquid lignin intermediate to form a biofuel component.

According to yet another specific embodiment, the stream of depolymerised lignin is discharged from the depolymerisation reactor and directly or indirectly charged ton extraction step in which step a solvent is added dissolving the depolymerized lignin.

Furthermore, the process disclosed above relating to forming a stream of depolymerised lignin may also involve one or more filtration steps after the depolymerisation step. Therefore, according to one embodiment of the present invention, the stream of depolymerised lignin being discharged from a depolymerisation reactor and/or a lignin containing stream from a subsequent extraction and/or acidulation step is passed through a subsequent filtration step in which water is added and in which the stream is separated into one aqueous stream comprising cooking chemicals being recovered or recycled and one stream having a content of organic substances. A stream of organic substances originating in lignin obtained by any of the procedures described herein may be purified by for example an acid treatment step, optionally in the presence of a solvent.

According to yet another embodiment of the present invention, a stream of depolymerised lignin is discharged from the depolymerisation reactor and separated from inorganic compounds in a subsequent separation step in order to form a purified liquid lignin product. The lignin product can advantageously be treated with hydrogen or hydrogen donor solvents in order to provide a fully deoxygenated lignin material. According to one specific embodiment relating to this context, there is provided a method comprising:
providing a spent cooking liquor feedstock
separating aqueous cooking chemicals and lignin from the black liquor feedstock by in one or more filtration steps-charging lignin to a depolymerisation reactor wherein lignin is depolymerised
separating depolymerised lignin from lignin particles and lignin oligomers
recycling lignin particles and lignin oligomers to the stream of aqueous cooking chemicals
discharging depolymerised lignin for further treatment by hydrogen or hydrogen donor solvents in order to provide deoxygenated lignin compounds.

Also in relation to the disclosed aspects of the present invention, the following embodiments should be further recognized. According to one embodiment, the spent cooking liquor is a kraft black liquor or origin from a kraft pulping process.

According to one specific embodiment, at least one of the filtration step and/or the subsequent filtration step is a membrane filtration step. According to another embodiment, both of the filtration step and the subsequent filtration step are membrane filtrations. Furthermore, the membrane filtration(s) may be e.g. nanofiltration and/or ultrafiltration.

Moreover, and according to yet another embodiment, the method also comprises at least one additional filtration step being performed before any acid treatment, said filtration step involving a separation of the input stream into one aqueous stream comprising cooking chemicals being recovered or recycled and one stream having a concentrated content of organic substances.

According to one embodiment, the solid/liquid separation step in which a solid lignin containing product is separated and recovered comprises at least one filter press step.

Moreover, the water content in the filtration step in which water is added may be up to 40 wt % when measured in relation to the input stream of spent pulping liquor flow. Furthermore, also in this case, the temperature in at least one of the filtration step and/or the subsequent filtration step is held above 85° C. Moreover, according to one embodiment the temperature is held in the range of 30-100° C. in any acid treatment step. Furthermore, according to one specific embodiment, the pH value is held below 10, such as in the range of 3-8, in an acid treatment step.

### DETAILED DESCRIPTION OF THE DRAWINGS

FIG. 1 shows one possible process flow set-up according to the present invention. According to this specific embodiment a spent pulping liquor stream is processed by subjecting it to a first filtration step involving fine ultrafiltration/nanofiltration (shown as FUF/NF). In this step there is a separation of one stream comprising cooking chemicals being recovered or recycled and a second stream having a concentrated content of organic substances, such as lignin and hemicellulose. This second stream is then further processed by subjecting it to a diafiltration step (marked as DF) which involves the addition of water. In this step there is separated one aqueous stream comprising cooking chemicals being recovered or recycled and another stream having a further concentrated content of organic substances (lignin/hemicellulose, etc.). The stream having a further concentrated content of organic substances is subjected to an acid treatment involving addition of acid and water. A precipitate comprising lignin, etc. is directed to solid/liquid separation, in this case a filtration, suitably passed through a filter press, for the final separation and recovery of a solid lignin containing product.

The set-up arrangement shown in FIG. 1 is suitable for a spent pulping liquor based on coniferous wood (softwood), but is not limited to such starting material. Moreover, it should be mentioned that the set-up shown is only an example and may e.g. comprise further filtration steps, e.g. similar to the ones disclosed or e.g. pre-filtration steps of another type. Furthermore, the final filtration step may instead consist of a centrifuge or another separation equipment type.

FIG. 2 shows another possible process flow arrangement according to the present invention. In this case, a pre-filtration step involving ultrafiltration (marked as UF) is incorporated as the first step. This step implies a separation of the input stream of spent pulping liquor flow into one stream with large undesired molecules and one stream intended to be further filtrated. This stream being further filtrated comprises both cooking chemicals and the organic substances intended to be recovered as a solid lignin containing product. The subsequent steps of filtration correspond to the steps shown in FIG. 1. This set-up embodiment shown in FIG. 2 is suitable for a spent pulping liquor based on deciduous wood (hardwood) where a pre-filtration step sometimes is preferred or necessary.

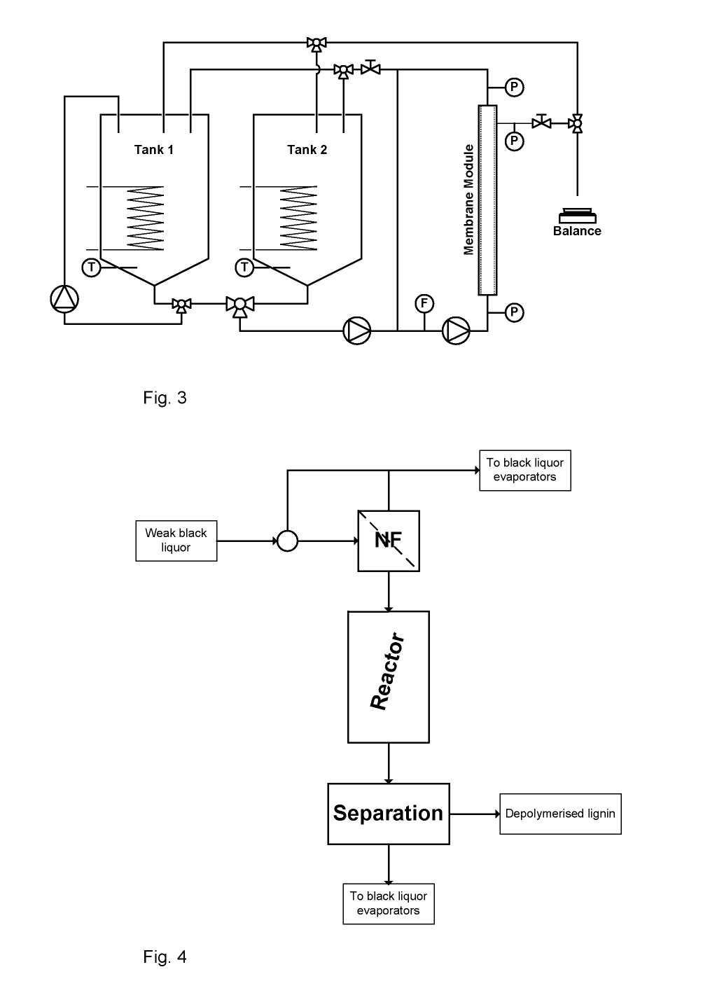

FIG. 3 shows the set-up during the trials disclosed below for ultrafiltration and nanofiltration, respectively, with ceramic membranes. This is further explained below.

FIG. 4 shows a process configuration for lignin separation including an integrated lignin depolymerisation step. In this particular embodiment a spent cooking liquor discharged from a digester or an evaporator, or discharged from any other step treating spent cooking liquor in between the digester and the evaporator, is passed through a filtration step in which the spent cooking liquor is separated into one aqueous stream comprising cooking chemicals being recovered or recycled and one stream having a concentrated content of lignin. The retentate from the filtration step concentrated with respect to lignin is passed directly without prior drying to a depolymerisation reactor in order to produce a stream of depolymerised lignin for export in liquid form to for example a petroleum refinery.

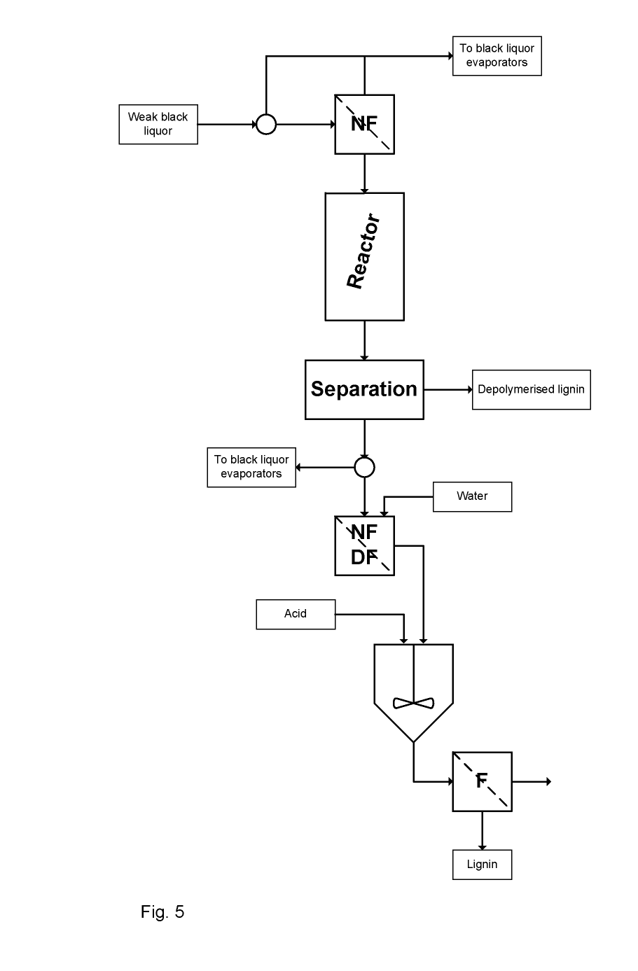

FIG. 5 shows another possible process flow set-up and embodiment also directed to depolymerisation of lignin integrated in a lignin filtration plant. As seen, in this case one stream of depolymerized lignin is discharged from a separation step following a nanofiltration step. A portion of the lignin discharged from the depolymerisation reactor (such as larger lignin particles), is passed via at least one filtration step in which water is added to then further exposed to an acid treatment for precipitation of lignin. After subsequent filtration, a solid lignin containing product is obtained.

### TRIALS AND EXAMPLES

Different experiments is support of the disclosures of the present invention have been conducted. Below two different experiment set-ups are summarized. A first set-up evaluated only nanofiltration of black liquor from both coniferous and deciduous tree, a second set-up evaluated a process involving ultrafiltration followed by nanofiltration of a similar starting material. In the nanofiltration trials four different membranes have been evaluated, one ceramic and three polymeric having different cut-off. Furthermore, in order to evaluate if a separation of hemicellulose from lignin in black liquor is possible, a cascade configuration involving ultrafiltration followed by nanofiltration was used. In this set-up, a ceramic ultrafiltration membrane was used.

### The Trial Set-Ups

Ultrafiltration and Nanofiltration with Ceramic Membranes

For the ultrafiltration and nanofiltration on the ultrafiltration permeate, respectively, the same experiment set-up was used. The set-up comprised two temperature controlled tanks in parallel having a volume of 200 liters each, a membrane module (for the ultrafiltration a M1 from A-tech Innovations GmbH, Gladbeck, Germany, was used, and for the nanofiltration a K01 from Orelis Environnement SAS, Salindres, France, was used) in which the ceramic membrane was installed, and two pumps of which one was used to pressurize the circuit and the second one was used to circulate the flow. The pressure was regulated with valves on the permeate side and the retentate side, respectively. The transmembrane pressure (TMP) was calculated in accordance with equation below, and was registered together with inter alia the flux by means of the software LABVIEW 2009 (National Instruments Co, Austin, Tex.).

$$TMP = \frac{{P}_{feed} + {P}_{ret}}{2} - {P}_{perm}$$

The cross-flow velocity was changed with the pump flow by means of a frequency converter (CD3100, Lust Antriebstechnik GmbH, Germany) and the flux was determined by means of weighing the permeate flow on an electrical balance (PL6001-S, Mettler-Toledo Inc., Columbus, Ohio). One of the tanks was used only when washing and cleaning, the other functioned as the feeding tank. The flow was measured with an electromagnetic flow meter (Fischer&Porter Co. Ltd., Gottingen, Germany) and the pressure in the feed stream, retentate stream and permeate stream with a pressure indicator (dTrans p02, Jumo A B, Helsingborg, Sweden). A schematic view of the set-up is shown in FIG. 3.

Nanofiltration of Black Liquor and Ultrafiltration of the Permeate with Polymeric Membranes

The trials with polymeric membranes were conducted using a somewhat smaller set-up facility, based on the same principals. Two temperature controlled tanks in parallel having a volume of 90 liters each were used. One of them was used only for cleaning and the start-up sequence, the other one was used as a feeding tank. Three membrane modules (diameter 0.5 inch, length 1 m) in series, where the polymeric membranes were installed and a pump were used. The pressure was controlled with a valve on the retentate side and was registered with two pressure indicators. The flow was measured with a vortex flow meter (Fischer&Porter Co. Ltd., Gottingen, Germany) and the flux was determined by electrical balances (PL6001-S, Mettler-Toledo Inc., Columbus, Ohio). The cross-flow velocity was regulated by means of the pump flow and the frequency converter (ELEX 4000, Bergkvist & Co AB, Gothenburg, Sweden). The software LABVIEW 2009 (National Instruments Co, Austin, Tex.) was used to register the operational conditions.

### Results of the Nanofiltration and Ultrafiltration Trials

The results obtained in the study show that a good separation of lignin is possible. For nanofiltration on untreated black liquor from coniferous wood the average flux was 159 I/m²h and a volume reduction of about 85% was obtained with the ceramic membrane, the corresponding value for the polymeric membrane was 82 I/m²h (in average) and a volume reduction of about 70%. The retention of lignin was 80% and 90%, respectively, for the ceramic membrane and the polymeric membrane. A high retention of lignin was desirable as one wants lignin to be obtained in the retentate. The lignin is then concentrated. Also hemicellulose was possible to extract from the black liquor. During the nanofiltration, the retention of hem icellulose was about 86% and 95%, respectively, for the ceramic membrane and the polymeric membrane. As such, a large amount of the hem icellulose was found in the retentate together with the lignin when both membranes were used.

As notable, desirable parameters are a high flux, a high volume reduction and a high retention of lignin. Although the polymeric membrane had a high retention, the ceramic membrane had a higher flux and a higher volume reduction. As such, the ceramic alternative may be of large economic interest as a higher flux and a higher volume reduction are important parameters when designing an economically sustainable process. Both membranes are of course possible according to the present invention.

By incorporating a single step of ultrafiltration before the nanofiltration, hemicellulose has been proven to be possible to separate from lignin. During the ultrafiltration the average flux was 183 I/m²h and reached a volume reduction of 93%. With reference to the subsequent nanofiltration, a polymeric membrane obtained an average flux of about 161 I/m²h and reached a volume reduction of about 84% at the concentrating step, while the ceramic membrane obtained a flux of about 250 I/m²h and a volume reduction of about 95%. Once again, a high flux and volume reduction may be desirable, and the ceramic membrane showed good results in that aspect. The retention of lignin was about 90% for the polymeric membrane, but almost 75% for the ceramic alternative. As such, the different membranes have different advantages when being compared to one another. When black liquor from deciduous was nanofiltrated the flux and retention was in the same range as when coniferous wood was used. The same applies when ultrafiltration was used as a pre-treatment method. However, during ultrafiltration of deciduous wood the average flux was 119 I/m²h which is lower than when black liquor from coniferous wood was used.

The results in the study are very promising, indicating that an up-scaled industrial process is feasible.

### Precipitation Trials

Precipitation and filtration trials at different pH values and temperatures of different retentates have been performed. The trials were performed in a bench-scale equipment consisting of a heat-controlled stirred tank reactor with a volume of approximately one liter and a feed system to ensure a well-controlled addition of 6M sulphuric acid.

Each precipitation experiment was started when the desired temperature was reached. The temperatures investigated varied between 35° C. and 100° C. Different stirring rates and feeding rates of sulphuric acid were also studied. The addition of acid continued until the desired pH-value of 2-7 was reached whereupon the solution was either passed through a filter of 40-100 pm or submitted to after-treatment before filtered. The filtration unit consisted of a Buchner funnel connected to vacuum or a Larox lab unit (Labox 25, Larox, Lappeenranta, Finland). After filtration, the filter cake was subjected to a washing liquor of water and acid in order to reduce the sodium content of the lignin containing solid product.

### Precipitation and Filtration Results

Precipitation and filtration of nanofiltration retentate of coniferous wood showed good results in the temperature interval of 80° C. to 90° C. At 70° C. the results were promising at lower pH-values. Considering nanofiltration retentate on black liquor pre-treated with ultrafiltration the corresponding interval was 60° C.-80° C. At 50° C. the results were sufficient, but not excellent (good results below).

Precipitation and filtration of deciduous wood was also studied. The trials of nanofiltrated black liquor showed sufficient results in the temperature range of 40° C.-60° C. Precipitation and filtration of nanofiltrated black liquor pre-treated with ultrafiltration shows good results in a temperature interval of 40° C.-50° C. At 60° C. sufficient results were obtained at the higher pH-values.

1. Precipitation and filtration of a nano/ultrafiltration retentate of coniferous wood

| | temperature | | | | | |
|---|---|---|---|---|---|---|
| pH | 60° C. | 70° C. | 80° C. | 90° C. | 95° C. | 100° C. |
| 7 | | Not sufficient | Good results | Good results | Not sufficient | Not sufficient |
| 4 | | Not sufficient | Good results | Good results | Not sufficient | Not sufficient |
| 2 | | Good results | Good results | Not sufficient | Not sufficient | Not sufficient |

2. Precipitation and filtration of a nano/ultrafiltration retentate of coniferous wood

| | temperature | | | | | |
|---|---|---|---|---|---|---|
| pH | 40° C. | 50° C. | 60° C. | 70° C. | 80° C. | 90° C. |
| 7 | Not sufficient | Sufficient results | Good | Good | Sufficient | Not sufficient |
| | | | results | results | results | |
| 4 | Not sufficient | Not sufficient | Sufficient | Good | Good results | Not sufficient |
| | | | results | results | | |
| 2 | Not sufficient | Not sufficient | Good | Good | Good results | Not sufficient |
| | | | results | results | | |

3. Precipitation and filtration of a nano/ultrafiltration retentate of deciduous wood

| pH/temperature | 40° C. | 50° C. | 60° C. | 70° C. | 80° C. |
|---|---|---|---|---|---|
| 7 | Not sufficient | Not sufficient | Not sufficient | Not sufficient | Not sufficient |
| 4 | Sufficient | Sufficient results | Sufficient | Not sufficient | |
| | results | | results | | |
| 2 | Sufficient | Not sufficient | Sufficient | Not sufficient | |
| | results | | results | | |

4. Precipitation and filtration of a nano/ultrafiltration retentate of deciduous wood

| | temperature | | | | | |
|---|---|---|---|---|---|---|
| pH | 35° C. | 40° C. | 45° C. | 50° C. | 60° C. | 80° C. |
| 7 | Not sufficient | Sufficient | Good results | Good results | Sufficient | Not sufficient |
| | | results | | | results | |
| 4 | Not sufficient | Good results | Good results | Good results | Not sufficient | |
| 2 | Not sufficient | Good results | Good results | Good results | Not sufficient | |

As notable from above, both the optimal pH value and the temperature depend on the process route and type of staring material, each other as such, etc.

### Precipitation and Filtration of Concentrated and Base Catalysed Black Liquor

Precipitation and filtration trials using retentate from membrane filtration of black liquor have been performed. The retentate from the membrane filtration was subjected to a lignin depolymerisation step involving base-catalytic heat-treatment before precipitation and filtration. No additional catalyst beyond the basic salts present in the retentates added. The depolymerisation was conducted during 2 hours at a temperature of 250° C. The lignin average molecular weight was decreased by approximately 50%.

The precipitation was performed in a bench-scale heat-controlled stirred tank reactor with a volume of approximately one litre. Concentrated sulphuric acid was kept in a burette to ensure a controlled addition to the black liquor solution. The experiment was started when the target temperature was reached. The temperature was varied between 30° C. and 100° C. Different stirring rates and addition rates of sulphuric acid were also investigated. The addition of the acid stopped when the solution reached the desired pH-value of 7-2.

When the correct pH-value was achieved the precipitated solution was kept at the same temperature for a certain period of time ranging from 0 min to 1.5 hours.

The filtration unit consisted of a pressurized vessel with a volume of about 0.6 litres. The filter used had a mesh size of 60 μm. The pressure used was 0.5 bar. After filtration the filter cake was washed with washing liquor consisting of distilled water and acid in order to wash out some of the sodium in the lignin.

### Results of the Precipitation and Filtration

The base-catalysed retentate had different properties compared to the original retentate since a depolymerisation occurred during the treatment. Both the lignin molecules and the hemicelluloses had smaller molecular weight distributions, which changed the properties of the lignin. The extracted lignin both had a different odor and colour compared to the lignin that was precipitated from concentrated black liquor alone.

The optimal precipitation temperature shifted towards lower values compared to the retentate subjected to UF before NF as described previously. Precipitation and filtration of deciduous wood showed good results for all pH in the interval at a temperature of 35° C. This was 10° C. lower than the optimal temperature achieved when UF was performed before NF.

The same results were obtained when membrane filtrated black liquor originating from coniferous wood was used. During these trials the optimal interval was somewhat lower than the corresponding interval reported when

UF was used before NF.

The filtration properties were found to be good for all precipitated lignin slurrys investigated.

1-49. (canceled)

50. A method for the production of a stream of depolymerised lignin in liquid form by the treatment of a kraft spent cooking liquor (black liquor) comprising lignin and spent kraft cooking chemicals, said method comprising:
a′) passing black liquor to one or more separation steps wherein the black liquor is divided into one or more aqueous alkaline streams comprising cooking chemicals and into one or more streams concentrated with respect to lignin;
a″) recycling cooking chemicals to a pulp mill chemicals recovery cycle;
b) passing or pumping a stream concentrated with respect to lignin from step a′ into a lignin depolymerisation step comprising one or more depolymerisation reactors in order to produce a stream of depolymerised lignin;
c) further treating the stream of depolymerised lignin from step b) in one or more acidulation steps, extraction steps and/or separation steps in order to produce a depolymerised lignin product, substantially free from spent cooking chemicals.

51. The method according to claim 50, wherein the temperature of black liquor fed into a separation step a′) is over 100° C.

52. The method according to claim 50, wherein the cooking chemicals being recycled to a pulp mill chemicals recovery cycle in step a″) have a pH above 11 and comprises a major portion of the NaHS and NaOH present in the black liquor charged to step a′).

53. The method according to claim 50, wherein a separation step in a′) and/or c) comprises one or more membrane filtration steps.

54. The method according to claim 53, wherein at least one of the one or more membrane filtration steps comprises recirculating retentate over a membrane module.

55. The method according to claim 53, wherein at least one of the one or more membrane filtration steps comprises dilution of the feed stream by an aqueous solvent.

56. The method according to claim 50, wherein at least 75% (by weight) of the total input of aqueous cooking chemicals charged to a separation step is recovered or recycled to a pulp mill chemicals recovery cycle.

57. The method according to claim 50, wherein depolymerisation of lignin is performed in a reactor at an elevated temperature in the range of 150 to 400° C. and a pressure in the range from 5 bar to 400 bar.

58. The method according to claim 50, wherein depolymerisation of lignin in a depolymerisation reactor is performed substantially without any catalyst added beyond catalytically active sodium compounds present in the feed stream to the lignin depolymerisation reactor.

59. The method according to claim 50, wherein one or more catalysts are added to be present during depolymerisation in the lignin depolymerisation step, such catalysts preferably selected among heterogeneous Ni, Cu, Mo and Zr catalysts on support, calcium compounds or potassium carbonate.

60. The method according to claim 50, wherein hydrogen gas or a hydrogen donor solvent is added to be present in a lignin depolymerisation step further supporting depolymerisation of lignin and/or decreasing the oxygen content of depolymerised lignin.

61. The method according to claim 50, wherein water and an organic solvent selected from one or more of an alcohol, an organic acid, an ester, and a hydrocarbon is present in at least one step of separation, depolymerisation, acidulation and extraction.

62. The method according to claim 50, wherein the stream of depolymerised lignin discharged from a depolymerisation step is further treated to form a liquid lignin containing oil which oil is further treated with hydrogen or hydrogen donor solvents in order to provide a stream of deoxygenated lignin compounds.

63. The method according to claim 50, wherein at least one of the separation steps is a liquid extraction step.

64. The method according to claim 50, wherein hydrolysates from separation of hemicellulose from wood or C1-C4 alcohols are present during depolymerisation of lignin in a depolymerisation step.
